(19) United States
(12) Patent Application Publication
(10) Pub. No.: US 2014/0037281 A1
(43) Pub. Date: Feb. 6, 2014

(54) CAMERA STABILIZATION APPARATUS AND METHOD OF USE

(71) Applicant: Peter L. Carney, Salt Lake City, UT (US)

(72) Inventor: Peter L. Carney, Salt Lake City, UT (US)

(21) Appl. No.: 13/958,535

(22) Filed: Aug. 3, 2013

Related U.S. Application Data
(60) Provisional application No. 61/679,070, filed on Aug. 3, 2012.

(51) Int. Cl. G03B 17/56

(52) U.S. Cl. CPC G03B 17/561
USPC 396/421

(57) ABSTRACT

The present invention is a dynamically balanced, light weight multifunctional, camera stabilization device that allows a film or digital video camera to be flown out of arms reach of the operator while still maintaining orientation toward the subject matter and can easily be configured to allow the camera to be oriented, above or below, the stabilization assembly.

This application claims priority to U.S. provisional patent application 61/679,070, filed Aug. 3, 2012 and is related to U.S. patent application 13/517,846, filed Jun. 14, 2012. The disclosures therein incorporated by reference.

### BACKGROUND OF THE INVENTION

A number of devices have been introduced to help film makers produce clear, stabile motion picture, home movies or video images, including, tripods, monopods, clamps, booms, etc. These devices work well when the camera is in a relatively fixed position and the subjects are in motion. However, these types of devices do not work well when it is necessary to have the camera in motion along with the subject and, this is especially true, when the camera is hand held or supported by a user.

There are some devices designed to stabilize a camera when it is hand held or supported by the user that are based on the principle of lowering the center of gravity of the assembly below a three-axis pivot point where the user's handle is attached, and by weighting the assembly to create a high moment of inertia. In this arrangement, the camera is allowed to pivot freely about the center of inertia of the whole filming apparatus, similar to the basic device shown in U.S. Pat. No. 2,007,215 to Remey, for a STABILIZED VIBRATION ABSORBING MOUNTING, filed Nov. 12, 1931. This type of camera stabilizer works on the principles of momentum, where the momentum of the camera and camera mounting above the three-axis pivot point is equal to the momentum of the counter-balance arms extending below the three-axis pivot point. This equally balanced, freely pivoting support, allows for, a clear and stable image even when the user's hand is shaking or oscillating, side to side, front to back or is canted. In most circumstances, even when the user's hand, holding the apparatus, moves off the center of the field of the view, the camera lens will continue to aim down the original line of focus.

Due to the requirement of a high moment of inertia, most camera stabilization devices are heavy and can be unwieldy. In order to accommodate the weight and size of the device, many of the stabilizers are attached to belts, harnesses or chest packs, such as the devices described in U.S. Pat. No. 4,017,168 to Brown, for EQUIPMENT FOR USE WITH HAND HELD MOTION PICTURE CAMERAS, filed Sep. 16, 1974 and U.S. Pat. No. 4,158,488 to Gottschalk, for BODY MOUNTED SUPPORT DEVICE FOR MOTION PICTURE CAMERA, filed Jul. 19, 1976. The stabilization feature and the camera are supported by an arm that is attached to the support harness and extends away from the user's body. In order to maintain orientation of the camera, the user is required to control the camera with at least one hand at all times. Some newer camera stabilization devices are designed to work with lighter weight cameras, such as, U.S. Pat. No. 4,946,272 to Brown, for STABILIZED EQUIPMENT SUPPORT, PRIMARILY FOR USE WITH LIGHT-WEIGHT CAMERAS, filed Sep. 22, 1988. However, these devices are inherently unstable and require the operator to employ both hands to control field of view and stability.

A limitation for each of these devices is that they cannot be extended away for the user or operator. In some situations it is necessary to extend the stabilized camera away from the user to avoid obstructions between camera and the subject being filmed or the user may simply desire to change the artistic perspective. There are options to extend the camera away from the user on a jib pole such as the device shown in U.S. Pat. No. 5,065,249 to Horn, for a PORTABLE VIDEO CAMERA/MONITOR SUPPORT, filed Sep. 26, 1988. However, this device does not include any form of stabilization and if combined with any of the other aforementioned devices, the user would not be able to reach up and control at least one axis of the camera in order to direct the shot or completely stabilize the image.

Another limitation of the above mentioned devices is that the stabilization device, with the camera, must maintain a single configuration or orientation, such as camera always on top of the stabilization counter-balance assembly or having the camera suspended below the stabilization assembly. It is recognized that having the camera on top of the stabilization device allows clear access to the camera controls and view finder and is convenient when extending the camera in front of the user. However, when the camera is mounted above the stabilization assembly, the stabilization assembly will interfere with filming at or near ground level. Any changes to the camera mounting position or orientation, if possible, would be a major mechanical endeavor.

What is needed is a camera stabilization device that can be jib or pole mounted allowing a camera to be “flown” out of arms reach of the user while still allowing the user to direct the field of view without directly manipulating the camera and allows the user to quickly change the camera orientation.

### SUMMARY OF THE INVENTION

The present invention is a dynamically balanced, light weight multifunctional, camera stabilization device that allows a film or digital video camera to be flown out of arms reach of the operator while still maintaining orientation toward the subject matter and can easily be configured to allow the camera to be oriented, above or below, the stabilization assembly.

One embodiment of the present invention or camera stabilization device is a camera stabilizer apparatus consisting of a camera mount having a plurality of at least three weighted counter-balance support legs. A three-axis rotatable bearing adjustably attached to the camera mount, at the center of inertia of the camera, camera mount and counter balance support leg weight assembly. A handle attached to the three-axis bearing, the rotational portion of the three-axis bearing having an adjustable friction device; allowing the user to pan the camera by rotationally manipulating the handle, while sharp rotations of the handle slip in the friction device preserving a smooth image. A receptacle or socket formed in the end of the handle allowing attachment of the complete apparatus to a jib pole assembly, painter's pole or microphone boom pole.

In one embodiment of the present invention or camera stabilization device the counter-balance support legs are configured as telescoping members having a weight attached at the free end. The attached portion of the telescoping support legs hinged to allow the legs to be positioned against the rotation handle, reducing the size of the device for transport or storage, or the legs can pulled away from the rotation handle, forming a stabile tri-pod assembly and increasing the moment of inertia. The moment of inertia of the device can be affected by changing the angle of the counter-balance support legs or by changing the length of the telescoping sections. When a lightweight camera such as small video camera, digital camera or a digital extreme sports camera is attached to the counter balance assembly, then the counter-balance support legs are spread into a partially open position with the telescoping legs extended, the counter-balance assembly will create a low moment of inertia and camera will oriented in an upright position. Whereas, if the telescoping counter-balance support legs are moved farther apart, or the length of the telescoping legs is reduced, the moment of inertia is raised in relationship to the three-axis bearing assembly, and the mass of the camera will force the counter balance assembly to rollover, resulting in the camera moving into an inverted position. It is typical that a user will maintain the spread of the counter-balance support legs against positive stops in the hinge assembly and simply reduce the length of each telescoping leg by about one-fourth, or one-third, to change the orientation. Most current digital cameras allow the user to select a mode where images filmed with the camera upside down will be stored and displayed in an upright position.

Another embodiment of the present invention includes a threaded height adjustment post connecting the three-axis bearing assembly to the camera base and counter-balance support leg assembly. Changing the length of the height adjustment post is an additional option available to adjust the moment of inertia of the assembly.

One embodiment of the present invention or camera stabilization device, the counter-balance legs having a plurality of removably attached weights. In one embodiment, the removable weights are the same mass in another embodiment the removable weights are a different mass or the mass of each weight is determined in a graduated series. Each of the plurality of support legs configured to receive a plurality of the weights. The user may choose to install a consistent number of weights on each of the plurality of support legs, however, if the configuration of the camera and camera mounting platform dictate, the user may increase the number of weights on one or more of the plurality of support legs.

In one embodiment, the bottom portion of the support legs has a screw thread allowing each individual weight to be threaded or spun unto the support leg. In another embodiment, the support legs, having a receiving rod or smooth portion where the individual weights, having a reciprocal hole drilled in the center, can be slid onto the receiving rod and the plurality of weights being securely fastened with a threaded or locking cap which attaches to the base of the support leg. In yet another embodiment, the plurality of weights friction or interference fit onto the base of the support leg. The total number of weights, the total mass of the weights added or the length of the support legs is dependent upon the mass of the camera mounted onto the system; if a camera is larger, having a substantial mass, additional mass or extended length must be added to the support legs to allow the moment of inertia of the counter-balance legs to substantially equal the moment of inertia of the camera. If a smaller camera is used, the total mass, the total number counter-balance weights or the length of the support legs can be reduced to achieve dynamic balance about the pivot point of the three-axis bearing.

In one embodiment of the present invention or camera stabilization device, the stabilizer includes three counter-balance support legs equally spaced around the camera mount. The counter-balance support legs angled outward to increase the moment of inertia and to create a support base out of the camera stabilizer device. The angle of the support legs can be collapsed completely to minimize space for storage, partially collapsed to minimize size for tight confines, or as spread apart as wide as practically possible to allow for the widest range of motion of the three-axis bearing and handle.

In one embodiment of the present invention or camera stabilization device, the counter-balance support leg length and/or weight can be set so that they are heavier than the camera and the camera will fly upright above the camera mount with the counter-balance support legs below. By shortening the counter-balance support leg length and/or reducing the support leg weight the present invention or camera stabilization device can be set so that the camera is heavier than the counter-balance support legs and the camera will fly, stabilized in an inverted position, with the camera below the camera mount and the counter-balance support legs above.

In one embodiment of the present invention or camera stabilization device, the counter-balance support leg length can be set equally, allowing the user to place the assembled device onto a flat surface, such as a table, and the camera maintaining a substantially level orientation. The user may use the device as a tripod or stationary support during filming or may place the device on a flat surface to allow the use of both hands while making adjustments to the device or to the camera. The user may also use the support legs as handles during filming. The assembled camera stabilization device can be stored while securely resting on the counter-balance legs.

One embodiment of the present invention or camera stabilization device, the handle is movably attached to the three-axis bearing and includes an adjustable friction device which allows the user to pan the camera smoothly by rotating handle. The adjustable friction device determines the amount of rotation of the handle that is translated through the three-axis bearing and into the camera mount, panning or changing the orientation of the camera laterally. The adjustable friction device may be a flat washer made of a material such as stainless steel, brass, bronze, plastic or a rubber o-ring. In another embodiment, the adjustable friction device may be a curved spring steel washer, where friction is increased by compressing the washer. Compression may be achieved by tightening a top compression nut or in another embodiment adjusting a collar compressing an o-ring to change rotational friction levels.

In one embodiment of the present invention or camera stabilization device, there may be a flexible member between the handle and the rotational bearing when the camera stabilization device is flown in the inverted mode, with the camera below and the support legs above the camera mount. The flexible member can be comprised of an elastomeric material having proper stiffness to support the weight of the complete system without kinking In another embodiment the flexible member can be a coil spring or the like. In another embodiment the flexible member can be a mechanical bearings and a curved support. The flexible member allows a gentle curvature between the handle and the three-axis bearing while still allowing rotational pan control in a clutched fashion over a much wider degree of angles than is possible with the three-axis bearing alone. The flexible member allows the jib pole to operate the camera stabilization device from 180 degrees straight down to close to vertical, all with clutched control of pan orientation.

In one embodiment of the present invention or camera stabilization device, the jib pole or rod is a fixed length. In another embodiment the jib pole or rod length is adjustable.

In one embodiment of the present invention or camera stabilization device, the handle may incorporate a ¾-5 ACME thread for use of a painters pole as the jib pole. In another embodiment of the present invention or camera stabilization device, the handle may incorporate a ⅝-27 or ⅜-16 microphone stand thread for use with US and European microphone boom poles as the jib pole.

These and other features and advantages of the disclosure will be set forth and will become more fully apparent in the detailed description that follows and in the appended claims. The features and advantages may be realized and obtained by the instruments and combinations particularly pointed out in the appended claims. Furthermore, the features and advantages of the disclosure may be learned by the practice of the methods or will be obvious from the description, as set forth hereinafter.

### BRIEF DESCRIPTION OF DRAWINGS

The following description of the embodiments can be understood in light of the Figures, which illustrate specific aspects of the embodiments and are part of the specification. Together with the following description, the Figures demonstrate and explain the principles of the embodiments. In the Figures the physical dimensions of the embodiment may be exaggerated for clarity. The same reference numerals in different drawings represent the same element, and thus their descriptions may be omitted.

FIG. 1 illustrates a detailed perspective view of the present invention or camera stabilization device in an upright configuration,

FIG. 2 illustrates a detailed perspective view of the present invention or camera stabilization device in an inverted configuration,

FIG. 3 illustrates a detailed perspective view of the present invention or camera stabilization device with the counter-balance support legs collapsed,

FIG. 4 illustrates a view of the three-axis bearing assembly of the present invention or camera stabilization device,

FIG. 5 illustrates actuation of one of the counter-balance support legs of the present invention or camera stabilization device,

FIG. 6 illustrates the present invention or camera stabilization device as used in an inverted configuration,

FIG. 7 illustrates the present invention or camera stabilization device as used in an upright configuration,

FIG. 8 illustrates the present invention or camera stabilization device as used in a hand-held upright configuration,

FIG. 9 illustrates the present invention or camera stabilization device as used with a flexible extension pole coupling, and,

FIG. 10 illustrates the present invention or camera stabilization device as used with a painter's pole.

### DETAILED DESCRIPTION OF THE INVENTION

For the purposes of promoting an understanding of the principles in accordance with the disclosure, reference will be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

As used in this specification and the appended claims, the singular forms “a,” “an,” and “the” include plural referents unless the context clearly dictates otherwise. In describing and claiming the present disclosure, the following terminology will be used in accordance with definitions set out below. The term camera mount refers to a molded or machined piece of steel, aluminum or plastic, capable of accommodating a camera, three or more counter-balance support legs and a three-axis bearing with handle attached. The camera mount is defined as a block designed to fixedly attach the camera, counter-balance support legs and three-axis bearing; the mounting may be accomplished using a thumb-screw threaded into the base of the camera, or it may be accomplished using a quick release mechanism as commonly known in the art. The counter-balance support legs are a plurality of telescoping rods, used for distribution of weight, to increase the moment of inertia centered about the pivot point of the three-axis bearing, used to support the assembly on a flat surface, and may be used as handles during filming. A handle as commonly known in at the art, wherein the user may grasp and support the camera stabilization device. Moment of inertia, as commonly known in the art, including the resistance of an object to movement about a point. Center of gravity as commonly known in the art. Three-axis bearing meaning a bearing capable of isolating each of roll, pitch and yaw, the bearing may be a u-joint, gimbal, or ball joint. The terms free-floating and multi-axis bearing may be used as a replacement for three-axis bearing. As used herein, the terms “comprising,” “including,” “containing,” “characterized by,” and the grammatical equivalents thereof are inclusive or open-ended terms that do not exclude additional, unrecited elements or method processes.

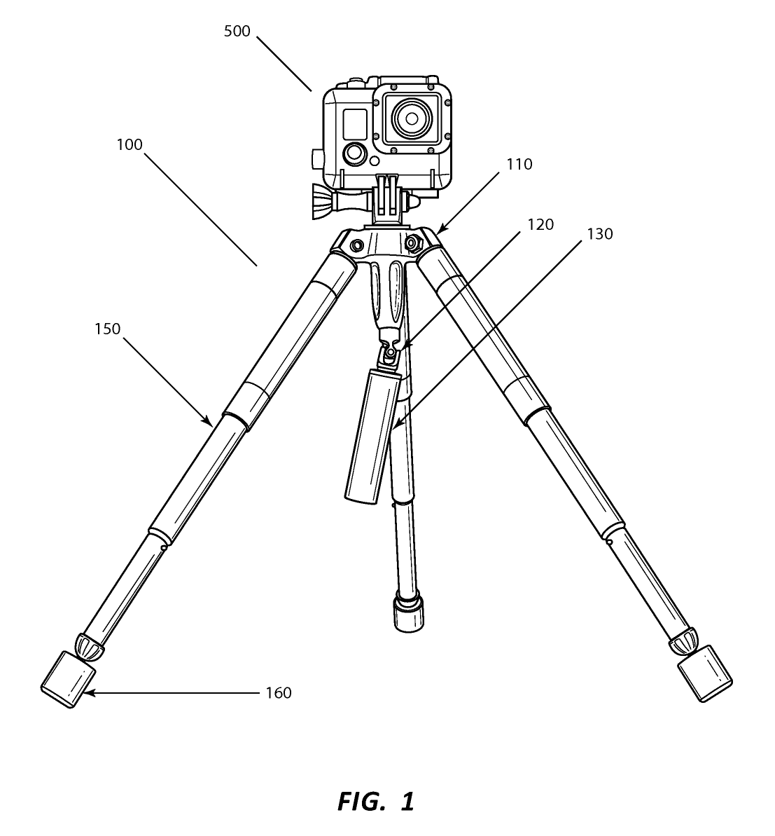

Illustrated in FIGS. 1 through 10, is one embodiment of the present invention or camera stabilization device 100. The camera stabilization device 100 includes a camera mount 110 where camera 500 and counter-balance support legs 150 and three-axis bearing 120 are attached.

The camera mount 110 includes a camera attachment point (not shown in detail), the attachment point may be a screw thread or may be a quick release mechanism used to securely attach a camera to the mount 110.

The three counter-balance support legs 150 are attached equally around the camera mount 110. In another embodiment of the present invention, it is contemplated that camera stabilizer device 100 may incorporate four support legs 150 or in yet another embodiment it is contemplated that more than four counter-balance support legs 150 are arranged evenly around the perimeter of the camera mount 110.

Support legs 150 may be angled outward or splayed from the camera mount 110 and set to an equal length, this arrangement creates a stable platform that can be rested on a flat surface and used as a fixed placement camera tripod or the camera stabilization device 100 can be stored resting on the support legs 150.

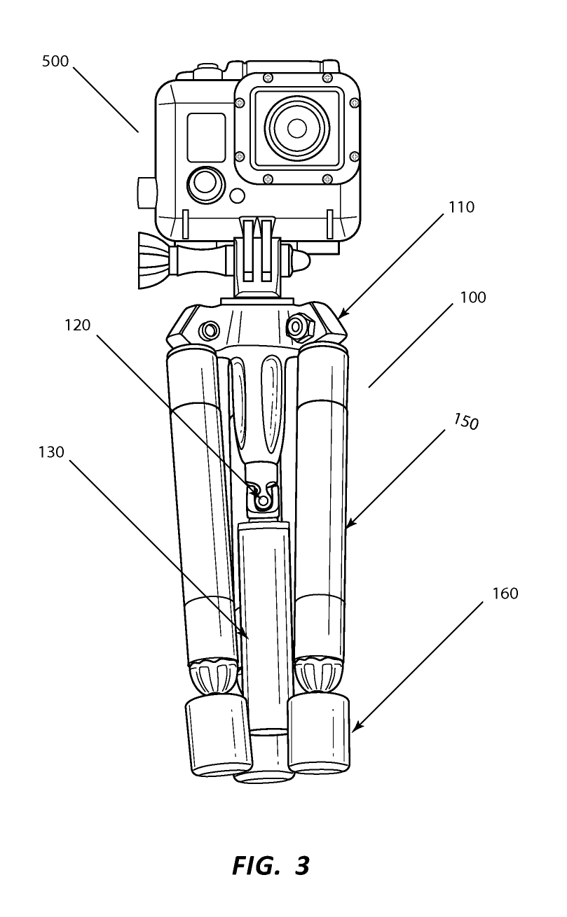

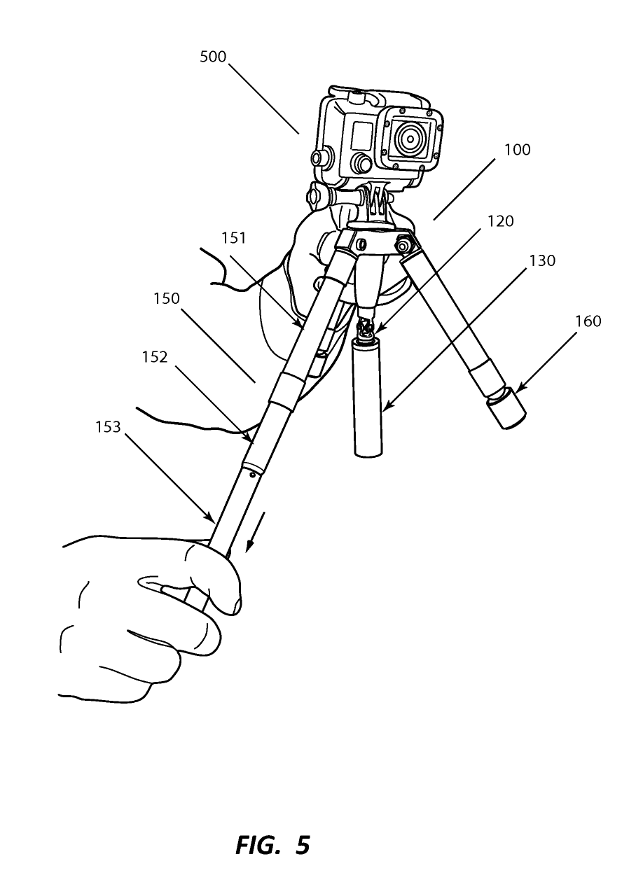

Each of the support legs 150 is configured to receive at least one counter-balance weight 160. The counter-balance weights 160 may be screwed onto a threaded rod section at the base of the support legs 150. In another embodiment the counter-weights 160 have a threaded screw section and a thread hole on the opposite side, the support leg 150 having a reciprocal threaded hole allowing attachment of a first counter-balance weight 160 to the base of the support leg 150 and second counter-balance weight 160 to be threaded into the hole of the first counter-balance weight 160. It is contemplated that counter-balance weights 160 may be attached to the support legs using a friction fit or may be attached using a keyed quick connect method as commonly known in the art. Support legs 150 are adjustable in length and angle relative to the camera mount 110. As shown in FIG. 3 support legs 150 are telescoped into a single section and folded in toward the handle assembly 130, thus forming a compact package for transportation or storage. FIG. 5 illustrates the user extending one of support legs 150 where the telescoping leg 150 is configured to have sections nested together when collapsed or retracted. It is typical for the upper most section, 151 to have an inside diameter to allow the second section 152 to nest inside, and final section 153 is sized to nest in the previous section 152. Other embodiments of the present invention may have telescoping legs 150 having two sections, four sections or more than four sections.

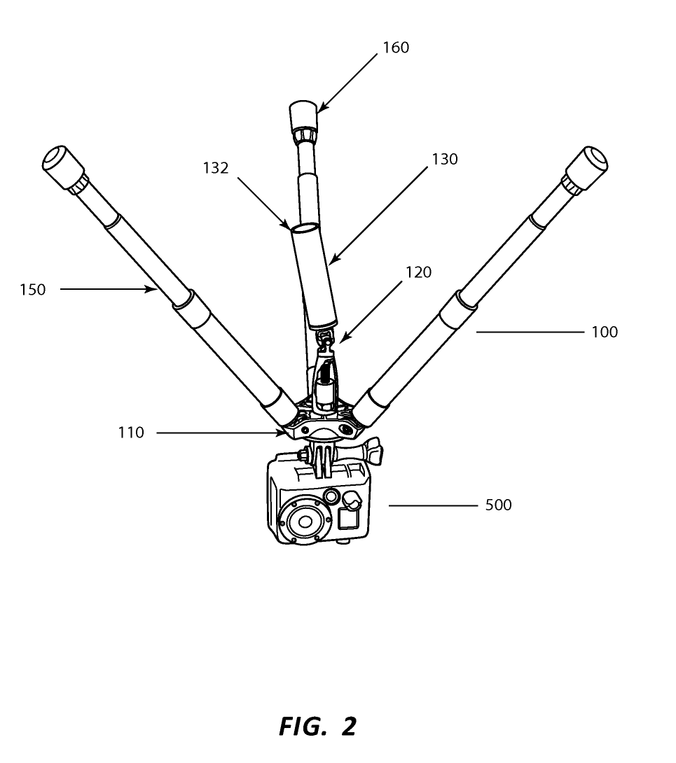

A three-axis bearing assembly 120, as shown in FIG. 2, is attached to the underside of camera mount 110. In one embodiment, the three-axis bearing assembly is moveably attached to the underside of the camera mount platform 110 using a threaded rod 121 which allows the user to change the moment of inertia of the assembled device 100 in relationship to the three-axis bearing 120. When the desired adjustment is made the user may tighten lock-nut 123 against the camera mount 110 and secure the adjustment using a lock-collar 122. A handle spline 131 allows for secure attachment of a handle.

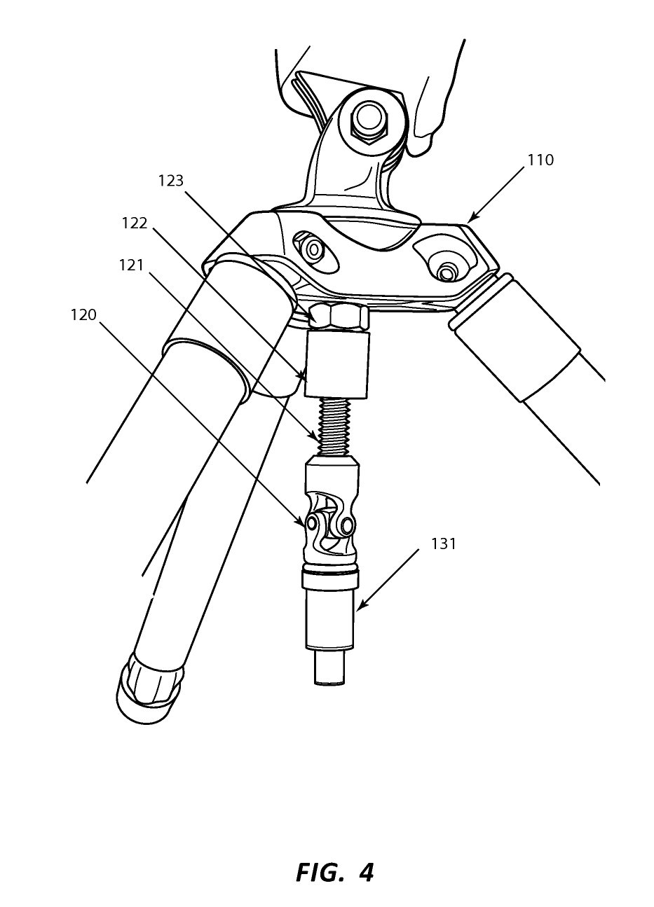

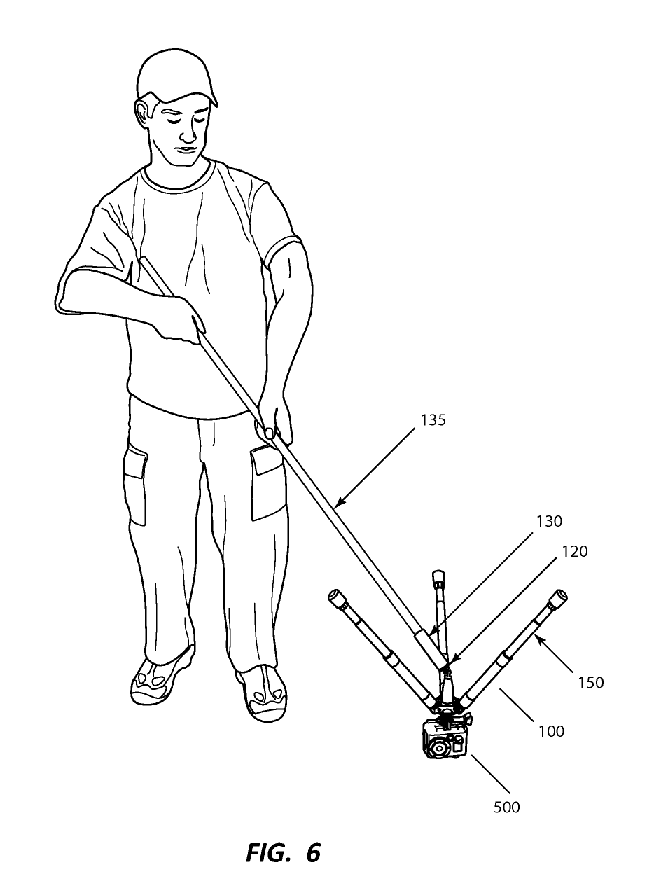

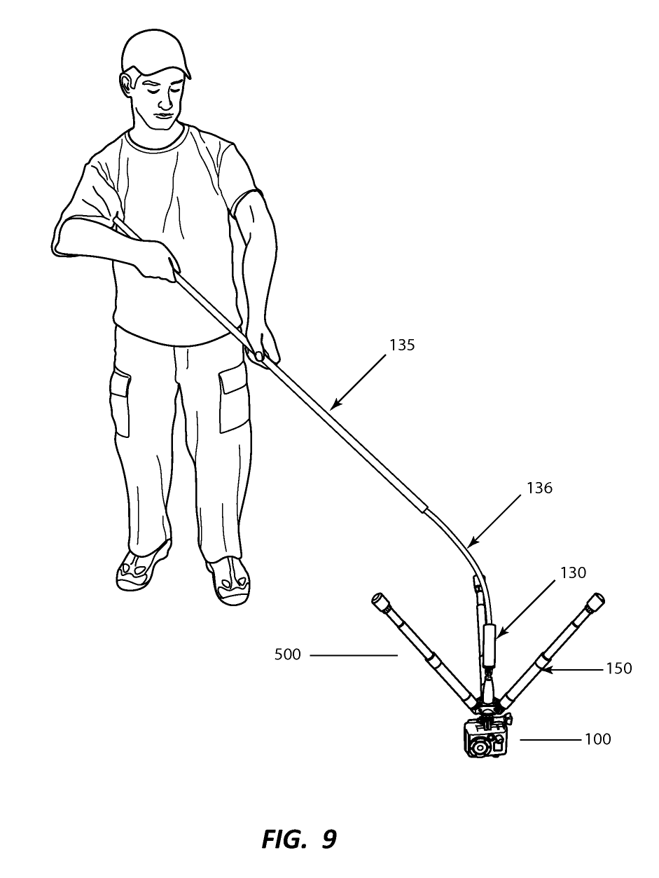

FIG. 6 illustrates one embodiment of the present invention or camera stabilization device 100 deployed in an inverted mode and using an extension pole 135 attached to handle 130. The user may change the moment of the inertia of the stabilization device 100 by one or a combination of more than one method or adjustment, including, changing the angle of the support legs 150, changing the length of the support legs 150, by changing the amount of counter-balance weight 160 or by adjusting the height of the three-axis bearing 120 using threaded rod 121 (FIG. 4). When the moment of inertia is moved to a position below the thee-axis bearing 120 to toward the counter-balance weights 160, the camera 500 will remain in an upright position. However if a user desires to fly the camera 500 in an inverted position, with most light-weight cameras, and in most arrangements, the user will simply move one section of each of the support legs 150 into a retracted position, moving the moment of inertia to the camera side of the three-axis bearing 120 and causing the device to invert. As discussed above this configuration may be desired when filming at ground level or when filming over an edge, such as rock or cliff to capture images of climbers. One embodiment of the present invention includes a flexible section 136, as shown in FIG. 9. The flexible section allows a camera 500 being flown on a jib pole 135 in an inverted position to be moved above parallel to the free end of the handle end of the jib pole 135 and prevents binding of the three-axis bearing 120.

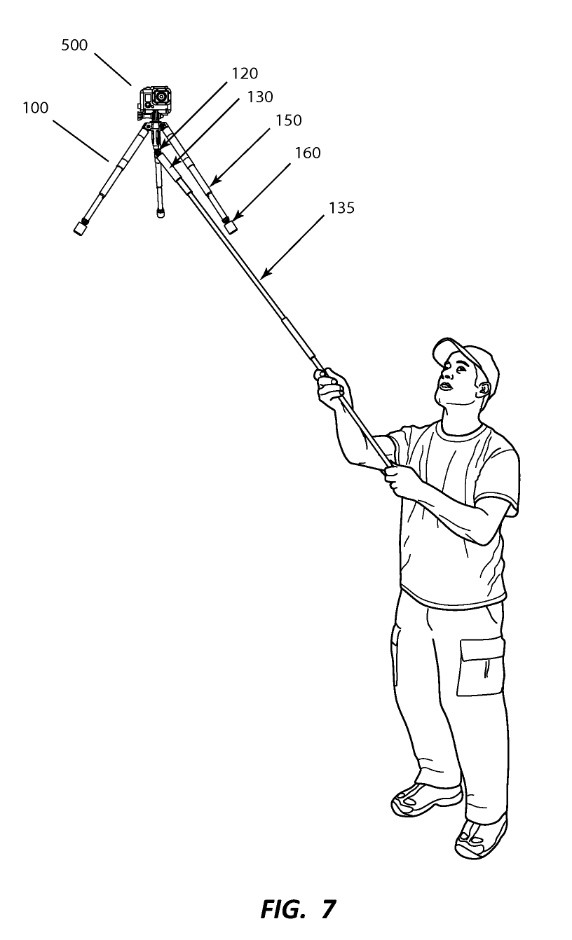

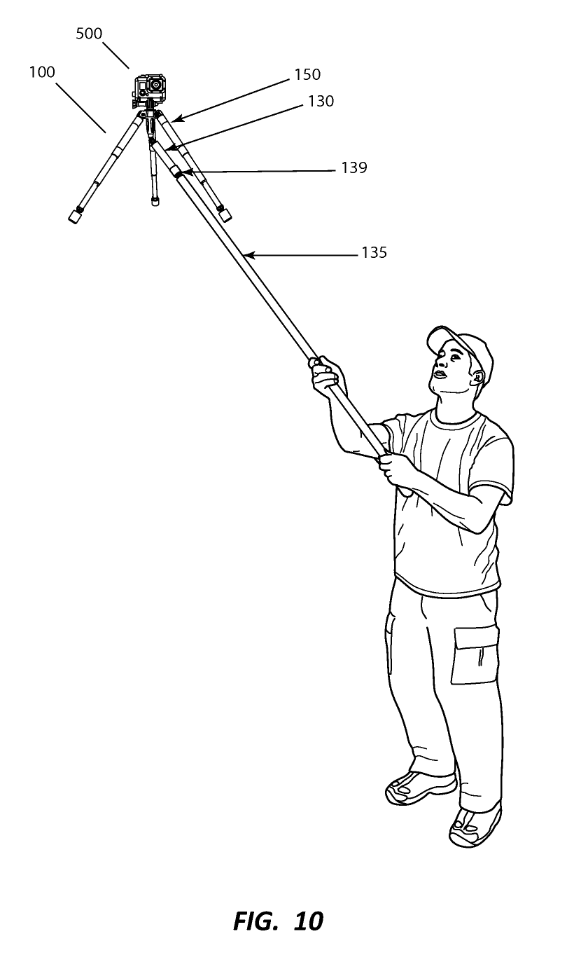

Illustrated in FIGS. 7 and 10, camera 500 and stabilization assembly 100 is being flown on a jib pole 135 in an upright configuration. The jib pole 135 connected to the base end of the handle 130 below the three-axis bearing assembly 120. In one embodiment, the handle 130 will have a socket 139 (FIG. 10) adapted to accept a ¾-5 ACME thread painter's pole or a broom handle. In yet another embodiment, handle 130 will have a socket 139 configured to accept a ⅝-27 or ⅜-16 thread microphone boom. It is contemplated that the jib pole 150 is a fixed length, is an adjustable length or has a plurality of sections that can be assembly to a desired length, such as lower jib pole section attached to the upper section at a union or splice sleeve.

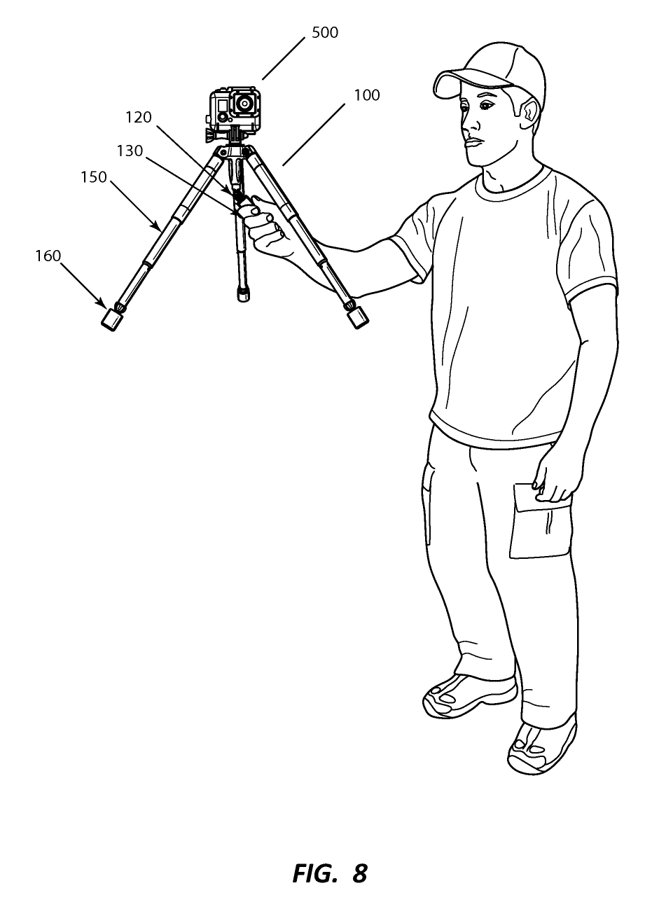

Illustrated in FIG. 8 is one embodiment of the present invention or camera stabilization device 100 deployed by the user by grasping handle 130. When camera stabilization device 100 is properly adjusted, the user may move handle 130, side to side or front to back, without adverse effect on image quality or changing the field of view of camera 500.

It is to be understood that the above mentioned arrangements are only illustrative of the application of the principles of the present disclosure. Numerous modifications or alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. A dynamically balanced camera stabilizer device comprising;
a camera mount
a plurality of three or more telescoping counter-balance support legs attached to the camera mount,
a control handle, and,
a three-axis bearing assembly installed at the attachment point between the control handle and the camera mount.

2. The camera stabilizer device of claim 1 wherein, the plurality of counter-balance support legs can include a plurality of removably attached counter-balance weights.

3. The camera stabilizer device of claim 2 wherein the moment of inertia of the device is changed by exchanging the plurality of counter-balance weights with counter-balance weights having a different mass.

4. The camera stabilizer device of claim 1 wherein, the plurality of counter-balance support legs have adjustable length.

5. The camera stabilizer device of claim 4 wherein the moment of inertia of the device is changed by changing the length of the plurality of counter-balance support legs.

6. The camera stabilizer device of claim 1 wherein, the plurality of counter-balance support legs can include an adjustable angle relative to the camera mount.

7. The camera stabilizer device of claim 6 wherein the moment of inertia of the device is changed by changing the angle of the plurality of counter-balance support legs.

8. The camera stabilizer of claim 1 wherein the three-axis bearing assembly may be adjustable up and down in relationship with the camera mount.

9. The camera stabilizer device of claim 1 wherein the moment of inertia of the device is changed by moving the three-axis bearing assembly up or down in relationship to the camera mount.

10. The camera stabilizer of claim 1 including a jib pole having one of,
a fixed length,
an adjustable length, and,
the control handle having a jib pole receiver.

11. The camera stabilizer of claim 10 wherein the jib pole assembly is attached to the control handle.

12. The camera stabilizer of claim 10 wherein the jib pole assembly and attachment comprises a ¾-5 acme thread painters pole.

13. The camera stabilizer of claim 10 wherein the jib pole assembly and attachment comprises a ⅝-27 or ⅜-16 thread microphone boom.

14. The camera stabilizer of claim 10 wherein the attachment end of the jib pole includes a flexible section.

15. A method of using a dynamically balanced camera stabilizer device comprising;
providing a camera mount,
providing a plurality of counter-balance support legs, the plurality of counter-balance support legs being adjustable in length,
providing a three-axis bearing assembly having a rotational component attached to the camera mount,
providing a control handle attached to the three-axis bearing assembly,
the control handle having a receiver for a jib pole assembly,
installing a camera on the camera mount,
extending or retracting the counter-balance support leg length to counter-balance the camera mass,
extending or retracting counter-balance support leg length to determine the upright or inverted orientation of the camera when balanced, and,
retracting counter-balance support leg length to reduce physical size for storage.

16. The method of claim 15 including;
providing a plurality of counter-balance weights attached to the plurality of counter-balance support legs,
exchanging counter-balance weights to counter-balance the camera mass, and,
exchanging counter-balance weights to determine the upright or inverted orientation of the camera when balanced.

17. The method of claim 15 including;
the plurality of counter-balance support legs being adjustable in angle relative to the camera mount,
adjusting the counter-balance support leg angle to change moment of inertia,
adjusting the counter-balance support leg angle to allow filming in tighter confines, and,
adjusting the counter-balance support leg angle to minimize physical size for storage.

18. The method claim 15 including;
providing a height adjustment between the three-axis bearing and the camera mount, and,
adjusting the height adjustment to change the moment of inertia.

19. The method of claim 15 including,
providing a jib pole assembly,
installing the jib pole assembly in the control handle receiver,
grasping the jib pole, and,
extending the jib pole and the camera away from the user to film.
